(19) United States
(12) Patent Application Publication
(10) Pub. No.: US 2019/0068535 A1
(43) Pub. Date: Feb. 28, 2019

(54) SELF-HEALING CONTENT TREATMENT SYSTEM AND METHOD

(71) Applicant: LinkedIn Corporation, Sunnyvale, CA (US)

(72) Inventors: Vineet Goyal, Bengaluru (IN); Sachin Kakkar, Karnataka (IN)

(21) Appl. No.: 15/688,275

(22) Filed: Aug. 28, 2017

(51) Int. Cl. H04L 12/58

(52) U.S. Cl. CPC H04L 51/12; H04L 51/22; H04L 51/32

(57) ABSTRACT

A machine is configured to correct erroneous automatic treatment of digital content items identified using, for instance, a locality sensitive hash model or a pattern matching model, and to address operational problems. For example, the machine accesses a signal value indicating that a content item is non-objectionable. The machine generates, based on one or more signal values associated with one or more near-duplicates of the content item, a score associated with the content item. The score indicates a level of objectionability of the content item. The machine modifies a status of the content item based on determining that the score does not exceed a threshold value associated with a treatment of content items. The modified status indicates that the content item is non-objectionable. The machine causes a display of an identifier associated with the content item in a user interface. The identifier indicates that the content item is non-objectionable.

### TECHNICAL FIELD

The present application relates generally to systems, methods, and computer program products for correction of erroneous automatic treatment of digital content items.

### BACKGROUND

Email spam, also known as unsolicited bulk email, or junk mail, became a problem soon after the general public started using the Internet in the mid-1990s. Unsolicited messaging is not limited to email. Examples of other types of spam are: instant messaging spam, Usenet newsgroup spam, web search engine spam, online classified ads spam, mobile phone messaging spam, internet forum spam, etc.

In some instances, providers of email services allow users to report the receipt of spam messages. Based on a spam report received from a user, a representative of the email service provider investigates the content of the reported spam message to determine if the message is indeed spam or is simply offensive to the particular user. If the reported message is determined to be spam, the email service provider may choose to block future messages from the sender of the spam message (also known as a “spammer”).

Because a large portion of the reported messages turn out not to be spam, human review of reported messages can be very wasteful of man-hours. In addition, the human review of reported spam messages tends to be very slow, and in the time that a person analyzes a reported message to determine if it is junk mail, the spammer may inundate an email service (or the Inboxes of the users of the email service) with thousands of unsolicited messages.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2A is a block diagram illustrating components of a content treatment system, according to some example embodiments;

FIG. 2B is a data flow diagram of a content treatment system, according to some example embodiments;

FIG. 2C is a data flow diagram of a content treatment system, according to some example embodiments;

FIG. 3 is a flowchart illustrating a method for correction of erroneous automatic treatment of digital content items, according to some example embodiments;

FIG. 4 is a flowchart illustrating a method for correction of erroneous automatic treatment of digital content items, and representing step 304 of the method illustrated in FIG. 3 in more detail, according to some example embodiments;

FIG. 5 is a flowchart illustrating a method for correction of erroneous automatic treatment of digital content items, and representing an additional step of the method illustrated in FIG. 4, according to some example embodiments;

FIG. 6 is a flowchart illustrating a method for correction of erroneous automatic treatment of digital content items, representing additional steps of the method illustrated in FIG. 3, and representing step 304 of the method illustrated in FIG. 3 in more detail, according to some example embodiments;

FIG. 7 is a flowchart illustrating a method for correction of erroneous automatic treatment of digital content items, representing an additional step of the method illustrated in FIG. 3, and representing step 304 of the method illustrated in FIG. 3 in more detail, according to some example embodiments;

FIG. 8A is a flowchart illustrating a method for correction of erroneous automatic treatment of digital content items, representing step 304 of the method illustrated in FIG. 3 in more detail, according to some example embodiments;

FIG. 8B is a flowchart illustrating a method for correction of erroneous automatic treatment of digital content items, representing the continuation of FIG. 8A, and representing step 304 of the method illustrated in FIG. 3 in more detail, according to some example embodiments;

FIG. 9 is a flowchart illustrating a method for correction of erroneous automatic treatment of digital content items, and representing additional steps of the method illustrated in FIGS. 8A and 8B in more detail, according to some example embodiments;

FIG. 10 is a flowchart illustrating a method for correction of erroneous automatic treatment of digital content items, representing an additional step of the method illustrated in FIGS. 8A and 8B in more detail, according to some example embodiments;

FIG. 11 is a block diagram illustrating a mobile device, according to some example embodiments; and

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems for correction of erroneous automatic treatment of digital content items on a Social Networking Service (hereinafter also “SNS”), such as LinkedIn®, are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

In some example embodiments, members of the SNS receive digital content via various services provided on the SNS. Some of that digital content is found objectionable by the receiving members. The receiving members may provide indications to a content treatment system associated with the SNS that they find the digital content objectionable. For example, a member of the SNS receives objectionable digital content in an Inbox provided by the SNS for the member, and marks the digital content as objectionable (e.g., transfers the objectionable digital content into a Spam folder).

The system associated with the SNS performs high confidence treatment of objectionable digital content based on receiving one or more signals that indicate that certain digital content is objectionable to one or more members of the SNS. An example of such high confidence treatment of objectionable digital content is pre-processing of messages flagged as objectionable by the members of the SNS, identifying and aggregating similar flagged digital content to either reduce the volume of digital content that requires human review or to block (e.g., to take down) the digital content that is determined to be associated with a plurality of indicators (e.g., signals) pointing to the digital content being objectionable.

In some instances, however, the content treatment system erroneously identifies certain digital content as objectionable, and blocks that digital content from being presented to members of the SNS. For example, digital content that generally would be considered non-objectionable to a majority of the members of SNS (e.g., a “Congratulations!” message) may be erroneously labeled as spam by the content treatment system, and stopped from being delivered to Inboxes of the members of the SNS. According to another example, a policy that designates what content is considered objectionable may change, and, therefore, the treatment of the digital content may change based on the changed policy.

It is technologically beneficial to implement a self-healing content treatment system for correction of erroneous automatic treatment of digital content items. The self-healing content treatment system (hereinafter also “self-healing system,” or “content treatment system”) may also address operational problems, such as latency, system shut-downs, etc., that may result from the classification of certain digital content as objectionable (e.g., spam).

In some example embodiments, the content treatment system associated with the SNS allows members to flag digital content (e.g., messages received in an Inbox, content displayed on a web page, etc.) as objectionable to report such messages to the system. The content treatment system may also allow members to unflag (e.g., flag as clean, unblock, un-report, etc.) digital content that was previously flagged as objectionable. The content treatment system may treat the flagging or unflagging of a particular digital content item by a member as a signal that indicates how the member perceives the particular digital content item. The data pertaining to a plurality of signals is aggregated and analyzed by the content treatment system to determine the treatment of various digital content items on the SNS.

A member of the SNS may flag an objectionable content item by, for example, selecting an objectionable content indicator (e.g., a button, a box, etc.) in a user interface of a client device. As a result of the member selecting the objectionable content indicator, the system generates a reporting event associated with the objectionable content item. Based on the reporting event, the system analyzes the objectionable content item to identify and execute a treatment for it.

The member of the SNS may unflag a digital content item that was previously flagged as objectionable by, for example, selecting a non-objectionable content indicator (e.g., a button, a box, etc.) in a user interface of the client device. As a result of the member selecting the non-objectionable content indicator, the system generates a reporting event associated with the non-objectionable digital content item. Based on the reporting event, the system may analyze the non-objectionable digital content item to identify and execute a treatment for it.

In some example embodiments, a member can unflag a digital content item that was previously marked as objectionable for multiple reasons, such as the member realizes that the member made a mistake with respect to the status of the digital content item, the member chooses to receive a certain type of digital content that was previously designated as objectionable, etc.

According to various example embodiments, a user interface has a feature (e.g., a user interface element such as a flag, a button, etc.) for a member of the SNS to select to unmark an item of digital content that had been marked as “objectionable.” For example, by unmarking, in a Spam folder, a message that was previously marked as “spam,” the member requests a change of the status of the message from “objectionable” to “non-objectionable.” Based on the selection by the member of an indicator associated with a request to unflag a previous objectionable message, a reporting event associated with the unflagged digital content item is generated at the client device and transmitted to the content treatment system. The reporting event may be generated by an application hosted on the client device.

Based on receiving, from the client device, a reporting event that refers to (e.g., includes) a signal pertaining to a status modification of a digital content item (e.g., a request from the member to unflag a previous objectionable message), the content treatment system determines whether the digital content item has been previously tagged as objectionable by content treatment system. A digital content item previously tagged as objectionable is associated with a final score value. Various input values may be used in the computation of the final score associated with the digital content item. In some example embodiments, the signal pertaining to a status modification of the digital content item from objectionable to non-objectionable is an input value in the computation of the final score associated with the digital content item.

For example, as more members request a change of status of a particular digital content item from objectionable to non-objectionable, the content treatment system receives more signals that the particular digital content item should be treated as non-objectionable, and a final score value associated with (e.g., for) the particular digital content item is dynamically adjusted (e.g., dynamically decreased) based on the signals pertaining to the status change of the particular digital content item that are received from the members. If the final score value associated with the particular digital content item falls below a threshold value, the content treatment system modifies the status of the particular digital content item (e.g., tags, labels, or marks the particular digital content item as non-objectionable) in a record of a database.

Another input value in the computation of the final score value of the digital content item, in some example embodiments, is a reputation value of the member who has unflagged the digital content item. A member's reputation value may vary over time based on how many good decisions a user makes regarding unflagging digital content previously marked as objectionable. As the member's decisions are compared against decisions, by a classification system (hereinafter also “classifier”), regarding the same content, the member's reputation value may increase. In some instances, the reputation value is be used as a factor in the computation of the final score value of the digital content item in order to minimize potential abuse of the content treatment system by spammers and their associated who may attempt to unflag actual spam messages.

Yet another factor in the computation of the final score value of the digital content item, in some example embodiments, is whether the author of the digital content item and the unflagging member are connected via the SNS (e.g., are first-level connections, are employed by the same company, etc.

In some example embodiments, a large number of near-duplicate digital content items of an objectionable digital content item may indicate the receipt of a large number of spam messages from a particular spammer, or that a simple message, such as “Congrats,” has been tagged as objectionable (e.g., has been flagged erroneously as a spam message) based on a high final score value. For example, if many members flagged the “Congrats” message as spam, the content treatment system may take down all “congrats” messages based on identifying a large number of near-duplicates of the flagged “Congrats” message. Based on an auto-alert indicating that the number of near-duplicates exceeds a threshold value, the content treatment system may trigger a review of the objectionable digital content item by a classifier (e.g., a machine classifier or a human reviewer). If the classifier marks the content as clean (e.g., non-objectionable), then the content treatment system unmarks one or more near-duplicates of the digital content item marked as clean. This assists in preventing the erroneous blocking of digital content items, such as “thanks” or “congrats.”

In some example embodiments, digital content that is received at the SNS is labelled by the content treatment system and stored in a database. Overtime, many similar items of digital content may be stored in the database. The storing of thousands of near-duplicate content items causes the content treatment system to experience latency in computing various values associated with the near-duplicate content items, and in identifying objectionable content. The content treatment system may include, in some example embodiments, an expiry logic to purge large-sized clusters of near-duplicates or older content. The content treatment system may include, in some example embodiments, an auto-timeout logic to release computation threads in order to maintain efficient near-duplicate identification and to avoid content classification latency.

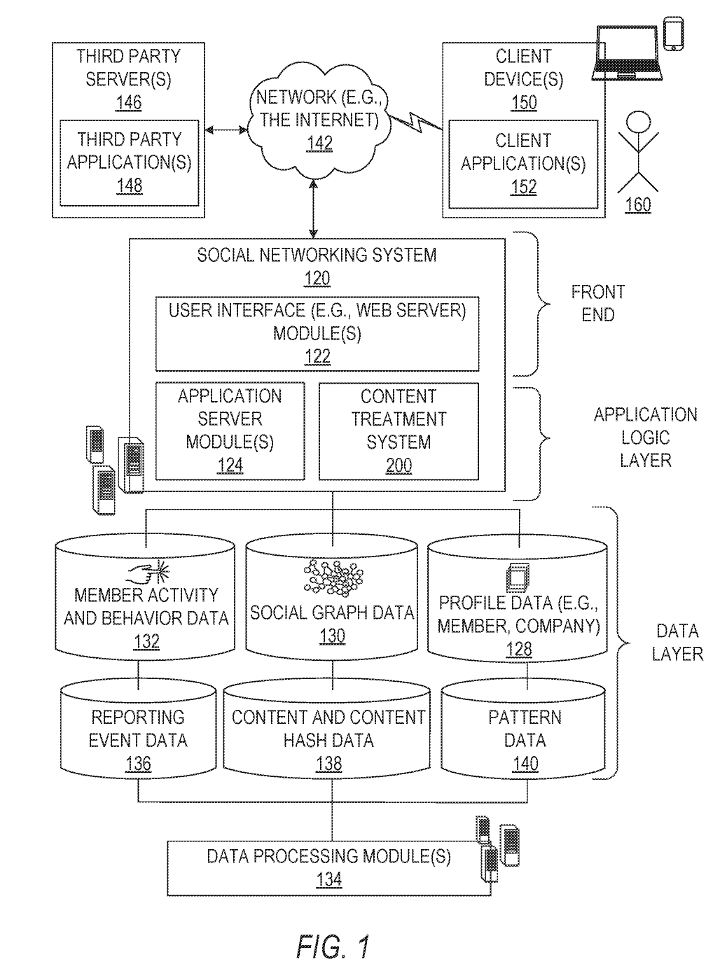

An example method and system for correction of erroneous automatic treatment of digital content items may be implemented in the context of the client-server system illustrated in FIG. 1. As illustrated in FIG. 1, the content treatment system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the SNS may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For example, an ad serving engine showing ads to users may be implemented with one or more application server modules 124. According to another example, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the content treatment system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, reporting event data, content data (e.g., the content of objectionable Inbox messages, the content of messages flagged-as-clean in a “blocked” (e.g., spam) folder), content hash data (e.g., hashes of digital content items), or pattern data (e.g., patterns of objectionable digital content), and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

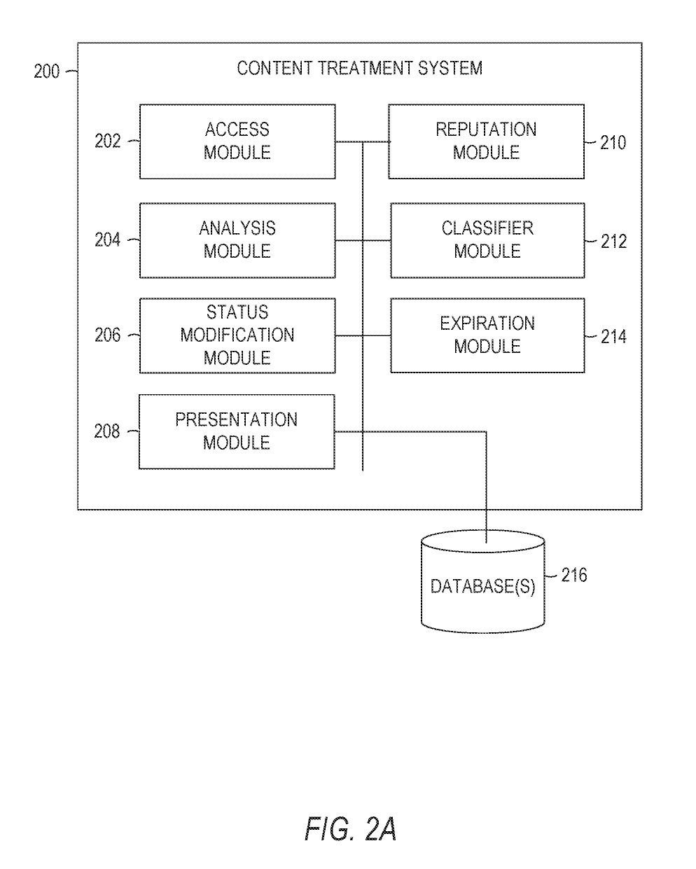

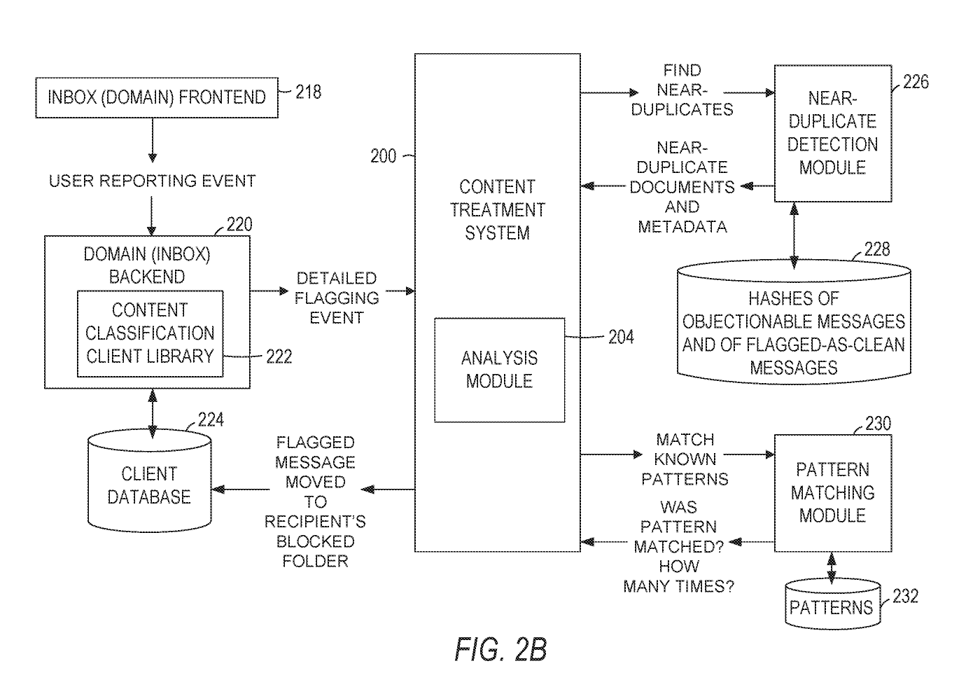

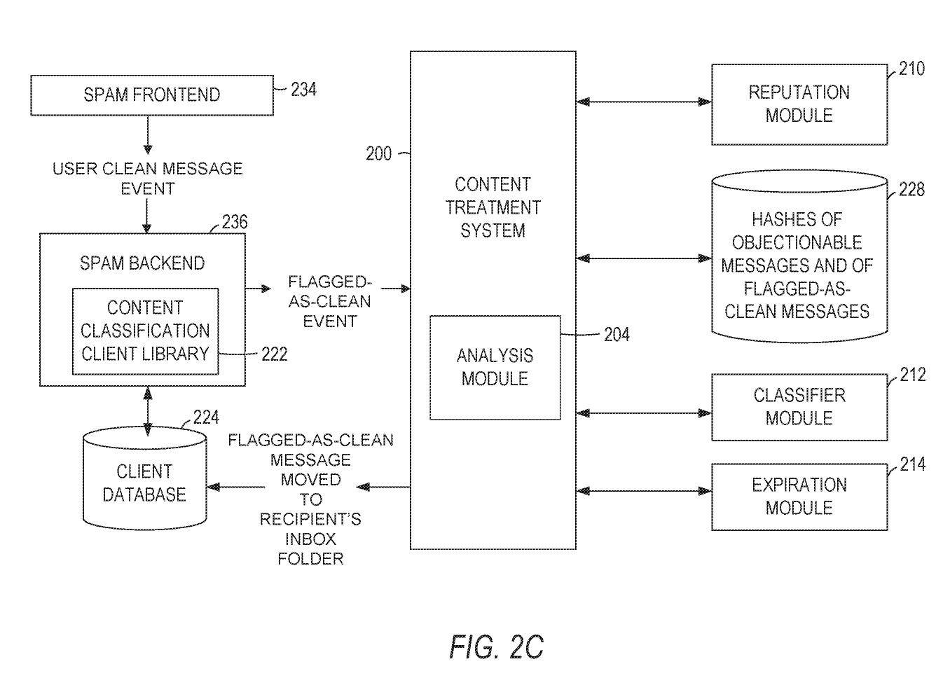

FIG. 2A is a block diagram illustrating components of the content treatment system 200, according to some example embodiments. As shown in FIG. 2A, the content treatment system 200 includes an access module 202, an analysis module 204, a status modification module 206, a presentation module 208, a reputation module 210, a classifier module 212, and an expiration module 214, all configured to communicate with each other (e.g., via a bus, shared memory, or a switch).

According to some example embodiments, the access module 202 accesses (e.g., receives) a signal value (e.g., an indicator, a flag, etc.) that indicates that a digital content item is non-objectionable. In some example embodiments, the signal value may be stored at and accessed from one or more records of a database (e.g., database 216). The signal value may be stored in association with an identifier of the digital content item, an identifier of a member of the SNS who designates the digital content item as non-objectionable, an identifier of an author of the digital content item, or a suitable combination thereof.

In some example embodiments, the signal value is received from a client device associated with the member. The signal value may be generated based on the member marking the digital content item as non-objectionable (e.g., in a spam folder associated with a mail client at the client device). For example, the member of the SNS may determine that a message in the member's Spam folder is non-objectionable (e.g., is not a spam message). The member may indicate, via a user interface (e.g., by clicking a user interface button that states “Unflag this message”) displayed on the member's client device, that the message is non-objectionable to the member. The client device may generate a communication that pertains to the non-objectionable message, and transmit the communication to the content treatment system 200. In some instances, the communication includes a reporting event (e.g., an unflagging event) that indicates that the member has designated (e.g., reported, etc.) the message as non-objectionable. The communication may also indicate an identifier of the message reported as non-objectionable. In some example embodiments, the accessing of the message reported as non-objectionable from one or more records of a database is based on the identifier of the message reported as non-objectionable.

The analysis module 204, in response to accessing the signal value, generates a final score value associated with (e.g., for) the digital content item. The final score value indicates a level of objectionability of the digital content item. In some example embodiments, the generating of the final score value is based on one or more signal values associated with one or more near-duplicates of the digital content item. The analysis module 204 also determines that the final score value does not exceed a threshold value associated with a treatment of digital content items.

The status modification module 206 modifies a status of the digital content item from objectionable to non-objectionable in a record of a database. The modifying of the status of the digital content item may be based on the determining that the final score value does not exceed the threshold value. The modified status indicates that the digital content item is a non-objectionable digital content item.

The presentation module 208 causes a display of an identifier associated with the digital content item in a user interface of a client device. The identifier indicating that the digital content item is non-objectionable.

The reputation module 210 generates a receiver reputation value associated with the member based on a classification of the digital content item in response to the accessing of the signal value that indicates that the digital content item is non-objectionable.

The classifier module 212 performs a classification of the digital content item as non-objectionable (or as objectionable) in response to the signal value generated at the client device. In some example embodiments, the classification is performed by a classification engine. In some example embodiments, the classification is performed by a human reviewer.

The expiration module 214 determines that certain processes (e.g., generating of final values, computations of hashes of digital content items, etc.) are slowing down. For example, the near-duplicate digital content items of a certain digital content item and the digital content item form a cluster of digital content items. As the number of near-duplicate digital content items for a certain digital content item grows in a cluster, querying the data pertaining to the near-duplicate digital content items to determine if a digital content item is a near-duplicate of another digital content item may become very slow. Certain Service Level Agreements (SLAs) may not be met by the SNS due to such a latency. Based on a determination that the hashes associated with the one or more digital content items are the same, the expiration module 214 may remove one or more digital content items in the cluster, and may keep a copy of the digital content item. In some instances, the expiration module 214 removes the older digital content items first.

In some example embodiments, the content treatment system 200 receives requests to process various data in parallel, and processes requests in parallel. If one of the requests is taking a long time to be processed because of a large cluster of near-duplicates, a timeout associated with one or more computations may occur. The content treatment system 200 may identify one or more timeouts occurring, and may generate an expiry signal value to trim clusters that are excessive in size. Based on the expiry signal, the expiration module 214 may delete digital content items older than a certain date, or may delete highly duplicate digital content items (e.g., digital content items identified to have a number of near-duplicates that exceeds a near-duplicate counter threshold value).

To perform one or more of its functionalities, the content treatment system 200 may communicate with one or more other systems. For example, an integration system may integrate the content treatment system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 216 (e.g., database 128, 130, 132, 136, 138, or 140).

FIG. 2B is a data flow diagram of a content treatment system, according to some example embodiments. In some example embodiments, a member can flag digital content as objectionable for multiple reasons, such as the digital content is considered adult content, the digital content is an unsolicited advertising, or the member simply does not like the content. However, an item of content that is objectionable to a member may not, in itself, be considered spam, or even considered objectionable by another member. Although an objectionable message report by a member of the SNS may be one input signal (e.g., a flag) in determining whether the reported message is spam, a single report, by itself, may, in some instances, not provide sufficient data for a machine-based determination whether the reported message includes content that warrants being filtered out from being delivered to members of the SNS. Additional data pertaining to the content of the reported message, and to whether the reported message is a near-duplicate of previously reported messages may be helpful in identifying an appropriate treatment for the reported message.

In some example embodiments, a content treatment system automatically determines the treatment for a digital content item associated with a reporting event based on automatic aggregation and analysis of various input signals (e.g., values) pertaining to the digital content item. Examples of treatments for objectionable digital content are de-ranking the item of digital content, hiding the item of digital content, limiting the distribution of the item of digital content, taking down the item of digital content, or blocking digital content associated with the identifiers (e.g., a member identifier (ID), an IP address, a domain name, etc.) of the author or sender of the item of digital content.

The machine-performed analysis of various input data pertaining to the messages reported as objectionable provides various technological benefits. Examples of such technological benefits are improved data processing times of one or more machines of the content treatment system, and more efficient data storage as a result of minimizing storage of spam content.

According to some example embodiments, the content treatment system accesses a message reported as objectionable (hereinafter also “a reported message,” “a flagged message,” or “an objectionable message”) by a member of a Social Networking Service (SNS) at a record of a database. The accessing of the message reported as objectionable by the member may be based on accessing a reporting event received in a communication from a client device. The communication may pertain to the message reported as objectionable by the member. The client device may be associated with the member.

The content treatment system identifies a digital content item included in the message reported as objectionable based on pre-processing the message. In some instances, the identifying of the digital content item based on the pre-processing of the message includes: removing Personal Identifiable Information (PII) from the message reported as objectionable, the removing of the PII resulting in a PII-free message, and performing a canonicalization operation on the PII-free message, the performing of the canonicalization operation resulting in the digital content item. Example of PII are a receiver's name, the receiver's email address, the receiver's phone number, and other personal or private information. Canonicalization (e.g., standardization or normalization) of a digital content item may include converting data that has more than one possible representation into a standard or canonical form.

The content treatment system determines one or more degrees of similarity between the digital content item and one or more other digital content items included in one or more other messages previously reported as objectionable by members of the SNS. The determining may be based on comparing a content of the digital content item and a content of the one or more other digital content items. The content treatment system generates a final score value associated with the digital content item based on the one or more degrees of similarity values between the digital content item and one or more other digital content items. The content treatment system executes a treatment for the message reported as objectionable based on the final score value associated with the content of the message.

In some example embodiments, before executing the treatment for the message reported as objectionable, the content treatment system accesses one or more treatment threshold values at a record of a database, compares the final score value and the one or more treatment threshold values, and selects the treatment based on the comparing of the final score value and the one or more treatment threshold values.

In various example embodiments, the one or more degrees of similarity between the digital content item and the one or more other digital content items are represented by one or more probabilities that the digital content item is a near-duplicate of the one or more other digital content items. In some instances, to determine the one or more degrees of similarity between the digital content item and the one or more other digital content items, the content treatment system generates one or more hashes of the digital content item based on performing locality-sensitive hashing of the digital content item, and generates the one or more probabilities that the digital content item is the near-duplicate of the one or more other digital content items based on matching the one or more hashes of the digital content item and one or more hashes associated with the one or more other digital content items.

In some instances, to determine the one or more degrees of similarity between the digital content item and the one or more other digital content items, the content treatment system generates one or more patterns of objectionable digital content based on an analysis of the one or more other digital content items, and generates the one or more probabilities that the digital content item is the near-duplicate of the one or more other digital content items based on matching one or more portions of the digital content item and the one or more patterns of objectionable digital content included in the one or more other digital content items.

The one or more probabilities that the digital content item is the near-duplicate of the one or more other digital content items may be input values in the computation of the final score associated with the digital content item.

The determining that the digital content item is a near-duplicate of one or more previously reported (or flagged as objectionable) messages may include matching the one or more hashes of the digital content item and one or more further hashes associated with the previously reported message. In some example embodiments, the generation and matching of a plurality of hashes for a digital item serves as basis for identifying near-duplicates, as opposed to identifying an exact match of the item. The content treatment system may, in various example embodiments use a locality sensitive hash (LSH) model, a minHash model, a Jaccard similarity model, or a suitable combination thereof, to identify syntactic near-duplicates of a given digital content item (e.g., a newly received text message or email message, etc.) from one or more other items of objectionable digital content already stored in a database associated with the content treatment system.

For example, LSH hashing generates a unique “fingerprint” that uniquely identifies a particular message. If two unique LSH fingerprints associated with two messages match to a certain high degree (e.g., 80%) then the content treatment system determines that the two messages are similar to that certain level (e.g., 80%). The high degree of similarity provides a high degree of confidence that the two messages are near-duplicates.

In addition to performing syntactic analysis of the reported message, the content treatment system also may perform semantic analysis of the reported message in order to determine whether it is a near-duplicate match of a previously reported message. The semantic analysis may include a translation of the digital content item from one or more languages to a canonical form (e.g., English).

In some instances, the generating of one or more patterns of objectionable digital content includes parsing previous objectionable messages (e.g., money fraud, scam, or promotional messages), and extracting keywords, expressions (e.g., regular expressions (regex)), etc. that define search patterns. Examples of pattern of objectionable digital content are: “My sincere apologies for this unannounced approach,” “I would like you to contact me via my email address,” “Please send me your phone number for further details,” “I have a business proposal, Kindly contact my email,” etc.

In some example embodiments, the content treatment system also determines the number of patterns matched, the number of times each pattern was matched, or both. In some instances, the content treatment system utilizes this information in the generating of score values for various digital content items and the determining of the appropriate treatment for digital content items based on the score values associated with the various digital content items.

According to some example embodiments, the utilization of various near-duplication detection models (e.g., a hash model, a pattern model, a machine learning model, an image classification model, etc.), solely or in combination, increases the machine-determined confidence level that a certain reported digital content item is or is not a spam message.

In certain example embodiments, the content treatment system may also compute score values for reported items of digital content based on determinations made using various near-duplication detection models (e.g., a hash model, a pattern model, a machine learning model, an image classification model, etc.) with regard to the reported items of digital content. The score values associated with the reported items of digital content may be used in the determination of the treatments to be applied to the reported items of digital content.

According to some example embodiments, every pattern is assigned a weight value Wi (with values between 0.00 and 1.00) which was determined offline based on how many times this pattern appeared in spam messages received at the SNS (e.g., messages which are determined to be spam, and labelled as such by human reviewers). The weight Wi represents a degree of severity (e.g., offense, harm, etc.) of a particular pattern.

In some example embodiments, the content treatment system determines a base score value of a flagged message to be:

S_baseᵢ=(W₁+W₂+ . . . +Wi)/(Total number of patterns matched),

where Wᵢ is the weight value of a particular pattern that matches a pattern in the digital content item.

The value of the S_baseᵢ score is stored in association with every flagged message in a record of a database.

The content treatment system also generates a final score value associated with the digital content item that serves as a basis for the selection and execution of a treatment for the message reported as objectionable. When the digital content item included in a flagged message is matched (e.g., syntactically and/or semantically) against one or more other digital content items included in one or more previously stored flagged messages, the content treatment system determines one or more degrees of similarity Sᵢ (with values between 0.00 and 1.00) between the digital content item and the one or more other digital content items.

In some example embodiments, the content treatment system determines the final score value associated with the digital content item based on the one or more degrees of similarity values between the digital content item and one or more other digital content items using the following formula:

S_finalᵢ=(S₁*S_base₁+S₂*S_base₂+ . . . +S_baseᵢ)/(Total number of previously stored, similar flagged messages found),

where Sᵢ is the degree of similarity value between the digital content item and another digital content item that was included in a previously reported message, and S_baseᵢ is the base score value of the other digital content item that was included in the previously reported message.

According to various example embodiments, the treatment of newly reported objectionable digital content (e.g., a new Inbox message) item is based on the final score value generated for it. The treatments may range from low severity to high severity. In some instances, each treatment action is associated with a corresponding threshold value in the range between “0.00” and “1.00.” A higher threshold value may represent a higher severity of treatment, and a lower threshold value may represent a lower severity of treatment. For example, a “Block the message” treatment action is associated with the highest threshold value of “1.00,” while a “No action” treatment action is associated with the lowest threshold value of “0.00.” In some example embodiments, some control statements may be represented as following:

if (S_finalᵢ > H₁)

T₁;

else if (S_finalᵢ > H₂)

T₂;

. . .
else if (S_finalᵢ > Hₙ)

Tₙ,

where S_finalᵢ is the final score value associated with a digital content item included in a newly reported message, and Hi are the threshold values corresponding to treatments Tᵢ.

Example filtering treatments, with increasing levels of severity, include: (a) no action on the similar content, but store it for future match against flagged content similar to this; (b) send it for human review to check if similar content needs to be treated; (c) provide a warning header to every message that is similar to this content; (d) take down all similar content by moving it to a “Spam/Blocked” folder, and send it for human review to check it needs to be cleared; (e) take down all similar content by moving it to a “Spam/Blocked” folder (e.g., auto-block).

As shown in FIG. 2B, in some example embodiments, an action by a user (e.g., a member of the SNS) reporting a spam message via an Inbox (Domain) Frontend 218 (e.g., a click on a “report as spam” button in a user interface) of a client device 150 results in the generation of a user reporting event at the Domain (Inbox) Backend 220 of the client device 150. The user reporting event may be stored, by a Content Classification Client Library 222, in a Client Database 224 at the client device 150. The Domain (Inbox_Backend 220 may communicate (e.g., transmit) a detailed flagging event to the content treatment system 200. The detailed flagging event may include various information pertaining to the flagged message (e.g., the content of the message, a sender identifier of the message, a time sent, a time received, a recipient's identifier, etc.).

In some example embodiments, the content treatment system 200 includes one or more modules for aggregation of signals pertaining to one or more messages reported as objectionable and/or for classification of digital content based on the various signals, a near-duplicate detection module 226 for the detection of near-duplicate objectionable messages, and a pattern matching module 230 for pattern analysis and matching. The functionality of one or more of the modules illustrated in FIG. 2B may be performed by one or more modules of FIG. 2A described above. For example, the near-duplicate detection module 226 and the pattern matching module 230 may be included in the analysis module 204 illustrated in FIG. 2A.

Upon accessing the reporting event (e.g., the detailed flagging event shown in FIG. 2B) pertaining to the message reported as objectionable, the content treatment system 200 accesses the reported message at a record of a database (e.g., a database associated with the content treatment system 200, the client database 224 associated with the client device, etc.). The content treatment system 200 identifies a digital content item referenced (e.g., included) in the reported message based on pre-processing the message. The pre-processing of the message may include removing PII from the reported message, and performing a canonicalization operation on the PII-free message. The performing of the canonicalization operation may result in the digital content item.

In some example embodiments, the content treatment system 200 determines how similar the reported message is to one or more other messages that were previously reported as objectionable by members of the SNS. The determining how similar the reported message is to previously reported messages may include determining one or more degrees of similarity between the digital content item and one or more other digital content items included in one or more other messages previously reported as objectionable.

According to some example embodiments, the determining of the one or more degrees of similarity includes generating, by the near-duplicate detection module 226, of one or more hashes of the digital content item, accessing, by the near-duplicate detection module 226, of one or more other hashes associated with the one or more other messages that were previously reported as objectionable (e.g., at a database 228 of Hashes of Objectionable Messages and of Flagged-As-Clean Messages), mapping, by the near-duplicate detection module 226, of the one or more hashes of the digital content item to the one or more other hashes associated with the one or more other messages that were previously reported as objectionable, and generating, by the near-duplicate detection module 226, of one or more probabilities that the digital content item is a near-duplicate of the one or more other digital content items based on the mapping. The near-duplicate detection module 226 may also transmit to another module of the content treatment system 200 a communication that includes the identified near-duplicate documents, and associated metadata for further processing and analysis.

According to various example embodiments, the determining of the one or more degrees of similarity includes accessing one or more other digital content items at a record of a database (e.g., the content and content hash database 138), generating, by the pattern matching module 230, of one or more patterns of objectionable digital content, and generating, by the pattern matching module 230, of one or more probabilities that the digital content item is a near-duplicate of the one or more other digital content items based on matching one or more portions of the digital content item and the one or more patterns of objectionable digital content included in the one or more other digital content items. The pattern matching module 230 may also transmit to another module of the content treatment system 200 a communication that includes an indication of which known patterns were matched by the one or more portions of the digital content item, and how many times they were matched.

In some instances, the one or more patterns of objectionable digital content are generated, and stored in a database 232 of patterns before the reporting event is received from the client device 150 (e.g., before the user reports the objectionable message). The content treatment system 200 may access the one or more patterns of objectionable digital content from the patterns database 232, and may generate the one or more probabilities that the digital content item is a near-duplicate of the one or more other digital content items based on matching one or more portions of the digital content item and the one or more patterns of objectionable digital content included in the one or more other digital content items.

In some example embodiments, the determining of the one or more degrees of similarity includes both the hash-based analysis of the digital content item and the pattern-based analysis of the digital content item described above.

The content treatment system 200 (e.g., the content scoring module 208) may generate a final score value associated with the digital content item based on the one or more degrees of similarity values between the digital content item and one or more other digital content items. The content treatment system 200 may execute a treatment for the message reported as objectionable based on the final score value associated with the content of the message. For example, the reported (e.g., flagged) message may be moved to the recipient's Blocked Folder on the client device 150.

FIG. 2C is a data flow diagram of a content treatment system, according to some example embodiments. As shown in FIG. 2C, in some example embodiments, an action by a user (e.g., a member of the SNS) marking a previously identified spam message as non-objectionable via an Spam Frontend 234 (e.g., a click on a “unflag message” button in a user interface associated with a spam folder of an email client) of a client device 150 results in the generation of a user clean message event at the Spam Backend 236 of the client device 150. The user clean message event may be stored, by a Content Classification Client Library 222, in a Client Database 224 at the client device 150. The Spam Backend 236 may communicate (e.g., transmit) a flagged-as-clean event to the content treatment system 200. The flagged-as-clean event may include various information pertaining to the unflagged message (e.g., the content of the message, a sender identifier of the message, a time sent, a time received, a recipient's identifier, etc.).

In some example embodiments, the content treatment system 200 includes one or more modules for aggregation of signals pertaining to one or more messages reported as non-objectionable and/or for classification of digital content based on the various signals. The functionality of one or more of the modules illustrated in FIG. 2C may be performed by one or more modules of FIG. 2A described above. Also, the content treatment system of FIG. 2C may include one or more modules described above with respect to FIG. 2B.

Upon accessing the reporting event (e.g., the flagged-as-clean event shown in FIG. 2C) pertaining to the message reported as non-objectionable, the content treatment system 200 accesses the unflagged message at a record of a database (e.g., a database associated with the content treatment system 200, the client database 224 associated with the client device, etc.). The content treatment system 200 identifies a digital content item referenced (e.g., included) in the unflagged message based on pre-processing the message. The pre-processing of the message may include removing PII from the unflagged message, and performing a canonicalization operation on the PII-free message. The performing of the canonicalization operation may result in the digital content item.

In some example embodiments, the content treatment system 200 determines how similar the unflagged message is to one or more other messages that were previously reported as objectionable by members of the SNS. The determining how similar the unflagged message is to previously reported messages may include determining one or more degrees of similarity between the digital content item and one or more other digital content items included in one or more other messages previously reported as objectionable. According to some example embodiments, the determining of the one or more degrees of similarity between the digital content item and one or more other digital content items previously reported as objectionable includes generating of one or more hashes of the digital content item, accessing of one or more other hashes associated with the one or more other digital content items that were previously reported as objectionable (e.g., at a database 228 of Hashes of Objectionable Messages and of Flagged-As-Clean Messages), mapping of the one or more hashes of the digital content item to the one or more other hashes associated with the one or more other messages that were previously reported as objectionable, and generating of one or more probabilities that the digital content item is a near-duplicate of the one or more other digital content items previously reported as objectionable based on the mapping.

In various example embodiments, the content treatment system 200 determines how similar the unflagged message is to one or more other previously unflagged messages. The determining how similar the unflagged message is to the one or more other previously unflagged messages may include determining one or more degrees of similarity between the digital content item and one or more other digital content items included in the one or more other previously unflagged messages. According to some example embodiments, the determining of the one or more degrees of similarity between the digital content item and one or more other digital content items included in the one or more other previously unflagged messages includes generating of one or more hashes of the digital content item, accessing of one or more other hashes associated with the one or more other digital content items included in the one or more other previously unflagged messages (e.g., at a database 228 of Hashes of Objectionable Messages and of Flagged-As-Clean Messages), mapping of the one or more hashes of the digital content item to the one or more other hashes associated with the one or more other digital content items included in the one or more other previously unflagged messages, and generating of one or more probabilities that the digital content item is a near-duplicate of the one or more other digital content items included in the one or more other previously unflagged messages.

According to some example embodiments, the content treatment system 200 (e.g., the analysis module 204) may generate a final score value associated with the digital content item based on the one or more degrees of similarity values between the digital content item and one or more other digital content items using the following formula:

S_finalᵢ=(Sₛ₁*S_baseₛ₁_{_}flaggedSpam+Sₛ₂*S_baseₛ₂_{_}flaggedSpam+ . . . +Sₛᵢ*S_baseₛᵢ_{_}flaggedSpam−S_{c1}*S_base_{c1}_{_}flaggedClean−S_{c2}*S_base_{c2}_{_}flaggedClean− . . . −S_{ci}*S_base_{ci}_{_}flaggedClean)/(Total number of previous digital content items detected as near-duplicates of the digital content item and flagged as Spam+Total number of previous digital content items detected as near-duplicates of the digital content item and flagged as Clean),

where Sₛᵢ is the degree of similarity value between the digital content item and another digital content item that was flagged as Spam (e.g., reported as objectionable), S_baseₛᵢ is the base score value of the other digital content item that was flagged as Spam, S_{ci} is the degree of similarity value between the digital content item and another digital content item that was flagged as Clean (e.g., reported as non-objectionable), S_base_{ci} is the base score value of the other digital content item that was flagged as Clean.

The final score value for a digital content item that is flagged as clean may decrease based on the content treatment system 200 detecting that one or more near-duplicates of the digital content item were also flagged as clean by one or more other members of the SNS. This allows the content treatment system 200 to self-heal based on aggregating data pertaining to inputs from various recipients who flag or unflag digital content items.

Accordingly, in some example embodiments, the content treatment system 200 accesses a first near-duplicate counter value at a record of a database. The first near-duplicate counter value identifies a first total number of previous digital content items that were detected as near-duplicates of the digital content item and that were reported as objectionable. The content treatment system 200 accesses a second near-duplicate counter value at the record of the database. The second near-duplicate counter value identifies a second total number of previous digital content items that were detected as near-duplicates of the digital content item and that were reported as non-objectionable.

The content treatment system 200 generates a first product between a first similarity value that identifies the degree of similarity between the digital content item and a first previous digital content item that was reported as objectionable, and a first base score associated with the first previous digital content item that was reported as objectionable. The content treatment system 200 generates a second product between a second similarity value that identifies the degree of similarity between the digital content item and a second previous digital content item that was reported as non-objectionable, and a second base score associated with the second previous digital content item that was reported as non-objectionable.

The content treatment system 200 subtracts the second product from the first product. The subtracting results in a difference between the first product and the second product. The content treatment system 200 aggregates the first total number of previous digital content items that were detected as near-duplicates of the digital content item and that were reported as objectionable, and the second total number of previous digital content items that were detected as near-duplicates of the digital content item and that were reported as non-objectionable. The aggregating of the first total number and the second total number results in a sum of the first total number of previous digital content items and the second total number of previous digital content items. The content treatment system 200 divides the difference between the first product and the second product by the sum of the first total number of previous digital content items and the second total number of previous digital content items. The dividing results in the final score value.

In some example embodiments, to generate the first base score associated with the first previous digital content item that was reported as objectionable, the content treatment system 200 accesses the digital content item associated with the signal value, and determines a number of matched patterns based on matching one or more portions of the digital content item and one or more patterns of objectionable digital content included in one or more other digital content items previously reported as objectionable. The content treatment system 200 also accesses a first weight value associated with a first pattern, the first weight value being determined based on a number of times the first pattern is included in one or more other digital content items previously reported as objectionable, and accesses a second weight value associated with a second pattern, the second weight value being determined based on a number of times the second pattern is included in one or more other digital content items previously reported as objectionable. The content treatment system 200 then aggregates the first weight value and the second weight value. The aggregating results in a sum of the first weight value and the second weight value. The content treatment system 200 generates the first base score associated with the first previous digital content item that was reported as objectionable based on dividing the sum of the first weight value and the second weight value by the number of matched patterns.

In some example embodiments, the content treatment system 200 generates the second base score associated with the second previous digital content item that was reported as non-objectionable based on at least one of a receiver reputation value (e.g., the reputation value associated with the member who unflags a message), an author reputation value, or an author-receiver relationship value. According to some example embodiments, the content treatment system 200 associates a greater reputation value with a member identifier of a member who correctly designates digital content as non-objectionable.

In various example embodiments, a receiver reputation value may be determined based on a static reputation value and a dynamic reputation value:

Receiver reputation value=W_{S}*Static Reputation+(1−W_{S})*Dynamic Reputation,

where W_{S} is a weight given to the static reputation value, and where 0<=W_{S}<=1.00.

In some example embodiments, the static reputation value associated with a member may be determined based on one or more profile attributes, such as the date of registration of the reporter (e.g., the date when the reporter signed up at the SNS, and/or became a confirmed member of the SNS), or the quality score value of the reporter's profile details. The profile quality score value of a reporter's profile details is a score which may be based on the type and number of profile fields that have been entered by the reporting member of the SNS. For example, a member who provides to the SNS information pertaining to the member's education, current role, and skills has a higher profile quality score value then another member whose profile only has a name and current title.

The dynamic reputation value may be based on the member's unflagging of digital content items. A dynamic reputation value may increase or decrease based on whether there is an agreement or disagreement between the decision of the member and a decision by a classification system, such as the classifier module 212. The classifier module 212 may analyze the digital content item, the metadata associated with the digital content item, or both, and may confirm or invalidate the designation, by the member, that the digital content item is non-objectionable. Based on a confirmation or an invalidation of the designation, by the member, that the digital content item is non-objectionable, the classifier performs a classification of the digital content item as non-objectionable or objectionable, respectively. Various classifiers may be associated with various levels of confidence that the decisions by the classifiers are correct. In some instances, a human classifier of content may be associated with a higher confidence level than an automatic classifier, and vice versa.

In some example embodiments, the dynamic reputation of a member may be determined based on a previous dynamic reputation value of the member and a confidence level associated with the classification system:

New Dynamic Reputation value=Previous Dynamic Reputation value+(A)*F(Confidence Level),

where A=1.00 if there is an agreement by the classifier with the member's designation of the digital content item as non-objectionable,
where A=−1.00 if there is a disagreement by the classifier with the member's designation of the digital content item as non-objectionable,
where F(Confidence Level) is a function of the confidence level associated with the classification system, and where 0<=Confidence Level<=1.00.

In various example embodiments, a sender's static reputation and a sender-recipient relationship (e.g., a first or second degree connection via the SNS) may be a factor in the classification of a digital content item. For example, a member who is new to the SNS and who sends messages to highly reputed members with whom the sending member is not connected via the SNS may be associated with a low static reputation value. The low static reputation value may be a factor in the automatic designation of the messages sent by the new member as spam.

Accordingly, in various example embodiments, the final score value of an unflagged message (e.g., a flagged-as-clean message) may be determined as a function of a receiver reputation value, a sender (e.g., author of the digital content) reputation value, and a relationship between them (e.g., a connection via the SNS):

Final Score Value of a flagged-as-clean message=fn(Receiver Reputation value, Sender Reputation value, relationship between the Sender and the Receiver),
where fn is a linear function.

The content treatment system 200 may execute a treatment for the message reported as non-objectionable based on the final score value associated with the content of the message. For example, the content treatment system 200 may move an unflagged message from the recipient's Blocked Folder on the client device 150 to an Inbox Folder on the client device 150 based on determining that the final score value associated with the unflagged message does not exceed a certain threshold value associated with messages that the content treatment system 200 designates as spam.

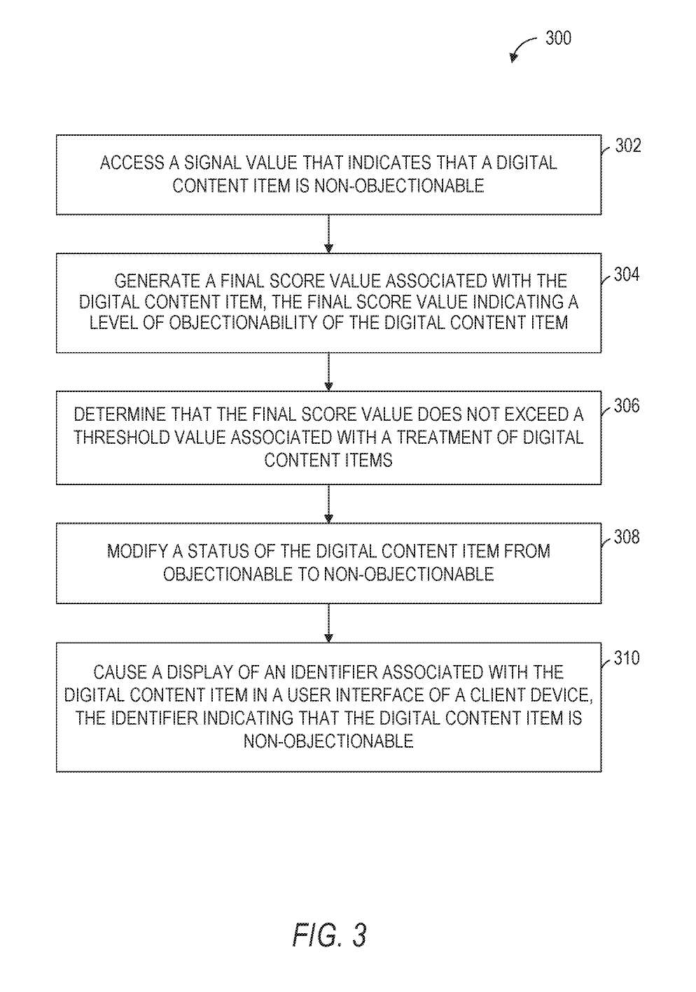

FIGS. 3-10 are flowcharts illustrating a method for correction of erroneous automatic treatment of digital content items, according to some example embodiments. Operations in the method 300 illustrated in FIG. 3 may be performed using modules described above with respect to FIG. 2A. As shown in FIG. 3, method 300 may include one or more of method operations 302, 304, 306, 308, and 310, according to some example embodiments.

At operation 302, the access module 202 accesses a signal value that indicates that a digital content item is non-objectionable. In some example embodiments, the signal value is received from a client device. The signal value may be generated at a client device associated with a member of the SNS based on an action pertaining to the status of the digital content item by the member of the SNS. For example, the signal value may be generated based on the member of the SNS marking the digital content item as non-objectionable in a spam folder associated with a mail client at the client device. Based on the generating of the signal value, the client device may transmit a communication (e.g., a reporting event) referencing (e.g., including) the signal value to the content treatment system 200.

At operation 304, the analysis module 204 generates a final score value associated with the digital content item. The generating of the final score may be in response to the accessing of the signal value. The final score value may indicate a level of objectionability of the digital content item. The generating of the final score value may be based on one or more signal values associated with one or more near-duplicates of the digital content item.

At operation 306, the analysis module 204 determines that the final score value does not exceed a threshold value associated with a treatment of digital content items. For example, the content treatment system 200 may move an unflagged message from the recipient's Blocked Folder on the client device 150 to an Inbox Folder on the client device 150 based on determining that the final score value associated with the unflagged message does not exceed a certain threshold value associated with messages that the content treatment system 200 designates as spam.

At operation 308, the status modification module 206 modifies a status of the digital content item (e.g., from objectionable to non-objectionable). The modifying of the status of the digital content item may be based on the determining that the final score value does not exceed the threshold value. The modified status may indicate that the digital content item is a non-objectionable digital content item.

At operation 310, the presentation module 208 causes a display of an identifier associated with the digital content item in a user interface of a client device. The identifier may indicate that the digital content item is non-objectionable.

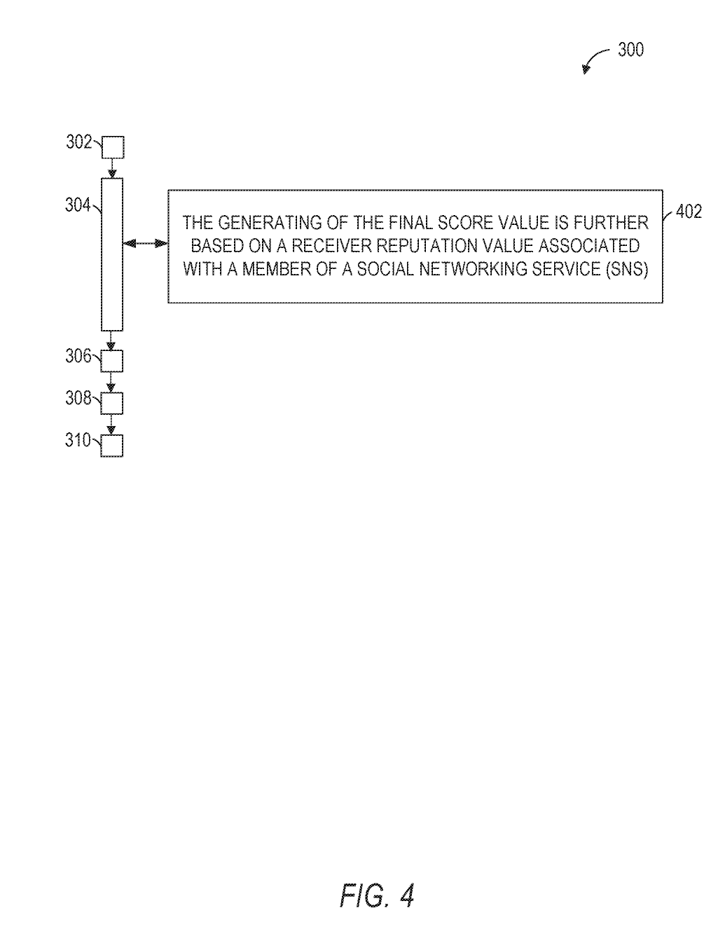

Further details with respect to the operations of the method 300 are described below with respect to FIGS. 4-10.

As shown in FIG. 4, the method 300 may include operation 402, according to some example embodiments. Operation 402 may be performed as part (e.g., a precursor task, a subroutine, or a portion) of operation 304, in which the analysis module 204 generates a final score value associated with the digital content item.

At operation 402, the analysis module 204 generates the final score value further based on a receiver reputation value associated with the member of the SNS. The member may be associated with the client device. The signal value may be generated at the client device based on an action pertaining to the status of the digital content item by the member.

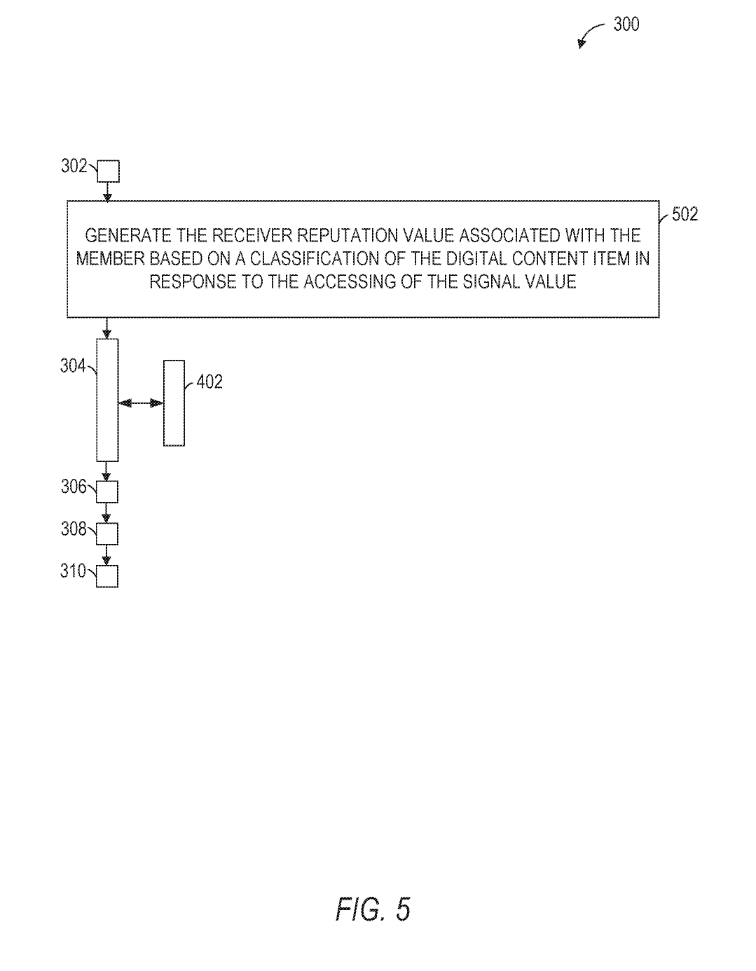

As shown in FIG. 5, the method 300 may include operation 502, according to some example embodiments. Operation 502 may be performed before operation 304 of FIG. 4, in which the analysis module 204 generates a final score value associated with the digital content item.

At operation 502, the reputation module 210 generates the receiver reputation value associated with the member. The generating of the reputation may be based on a classification of the digital content item in response to the accessing of the signal value that indicates that the digital content item is non-objectionable. In some example embodiments, the classification is performed by a classification engine. In some example embodiments, the classification is performed by a human reviewer. A classifier (e.g., a classification engine, a human reviewer, etc.) may analyze the digital content item, the metadata associated with the digital content item, or both, and may confirm or invalidate the designation, by the member, that the digital content item is non-objectionable. Based on a confirmation or an invalidation of the designation, by the member, that the digital content item is non-objectionable, the classifier performs a classification of the digital content item as non-objectionable or objectionable, respectively. In some example embodiments, the functions of a classification engine are performed by the classifier module 212.

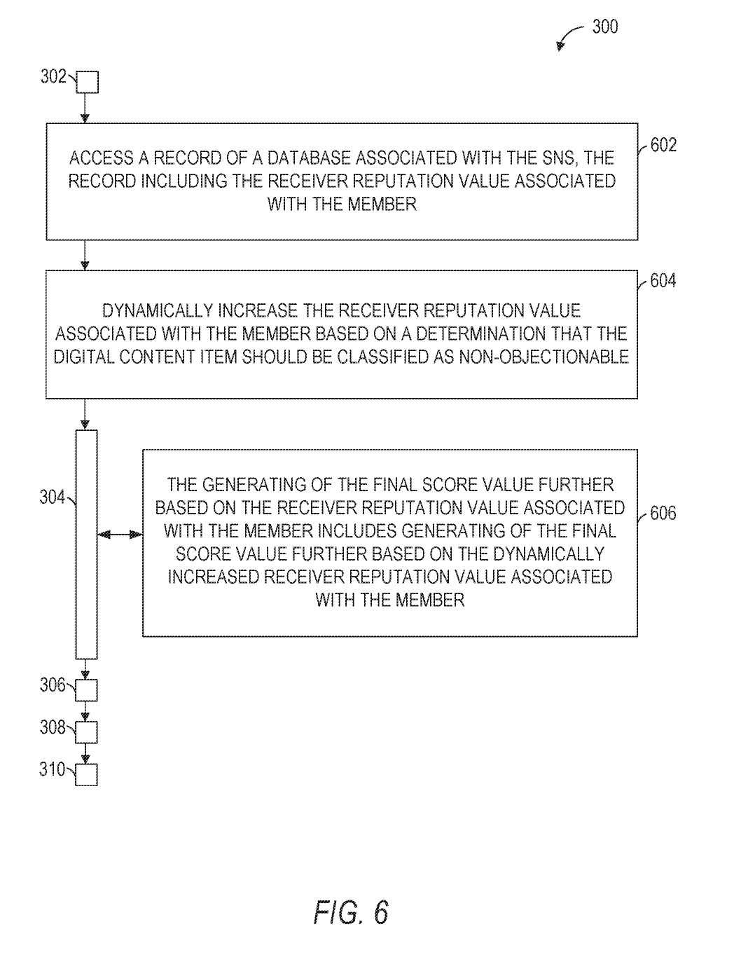

As shown in FIG. 6, the method 300 may include one or more of the operations 602, 604, or 606, according to some example embodiments. Operation 602 may be performed after operation 302 of FIG. 3, in which the access module 202 accesses a signal value that indicates that a digital content item is non-objectionable.

At operation 602, the access module 202 accesses a record of a database associated with the SNS. The record may include the receiver reputation value associated with the member.

At operation 604, the reputation module 210 dynamically increases the receiver reputation value associated with the member. The dynamic increasing of the receiver reputation associated with the member may be based on a determination that the digital content item should be classified as non-objectionable.

Operation 606 may be performed as part (e.g., a precursor task, a subroutine, or a portion) of operation 304 of FIG. 3, in which the analysis module 204 generates a final score value associated with the digital content item. At operation 606, the analysis module 204 generates the final score value further based on the dynamically increased receiver reputation value associated with the member.

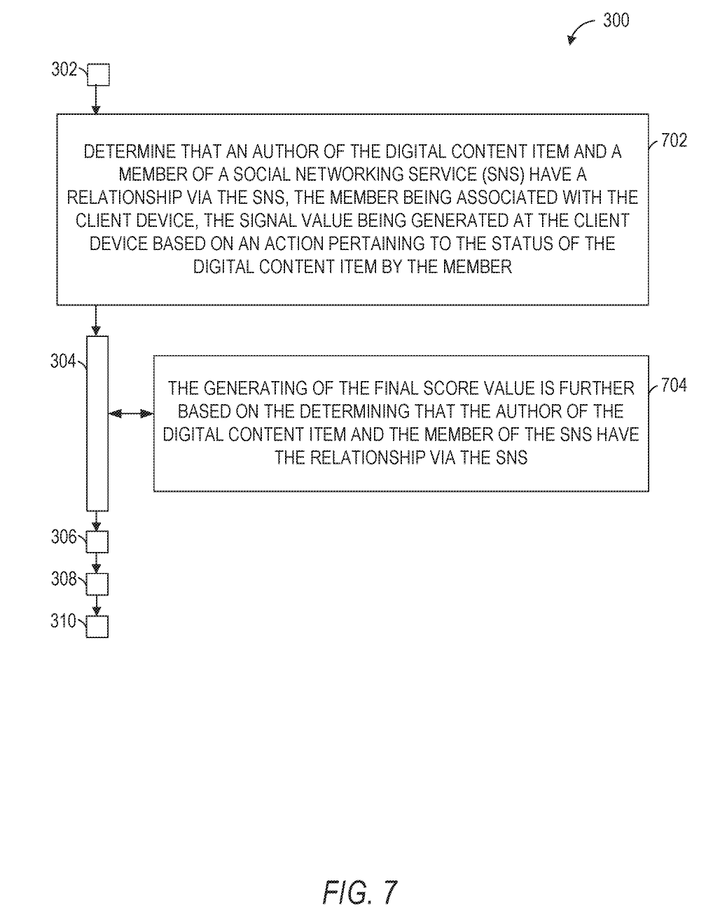

As shown in FIG. 7, the method 300 may include operations 702 or 704, according to some example embodiments. Operation 702 may be performed after operation 302 of FIG. 3, in which the access module 202 accesses a signal value that indicates that a digital content item is non-objectionable.

At operation 702, the analysis module 304 determines that an author of the digital content item and a member of the SNS have a relationship via the SNS. The member may be associated with a client device from which the signal value is accessed. The signal value may be generated at the client device based on an action pertaining to the status of the digital content item by the member.

Operation 704 may be performed as part (e.g., a precursor task, a subroutine, or a portion) of operation 304 of FIG. 3, in which the analysis module 204 generates a final score value associated with the digital content item. At operation 704, the analysis module 204 generates the final score value further based on the determining that the author of the digital content item and the member of the SNS have the relationship via the SNS.

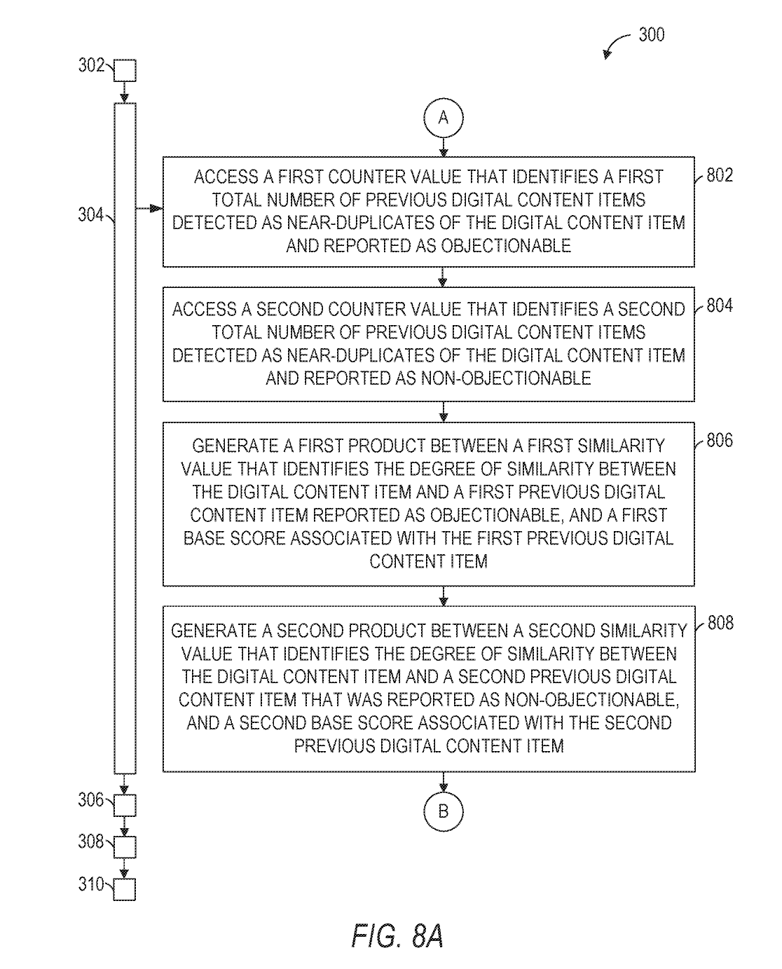

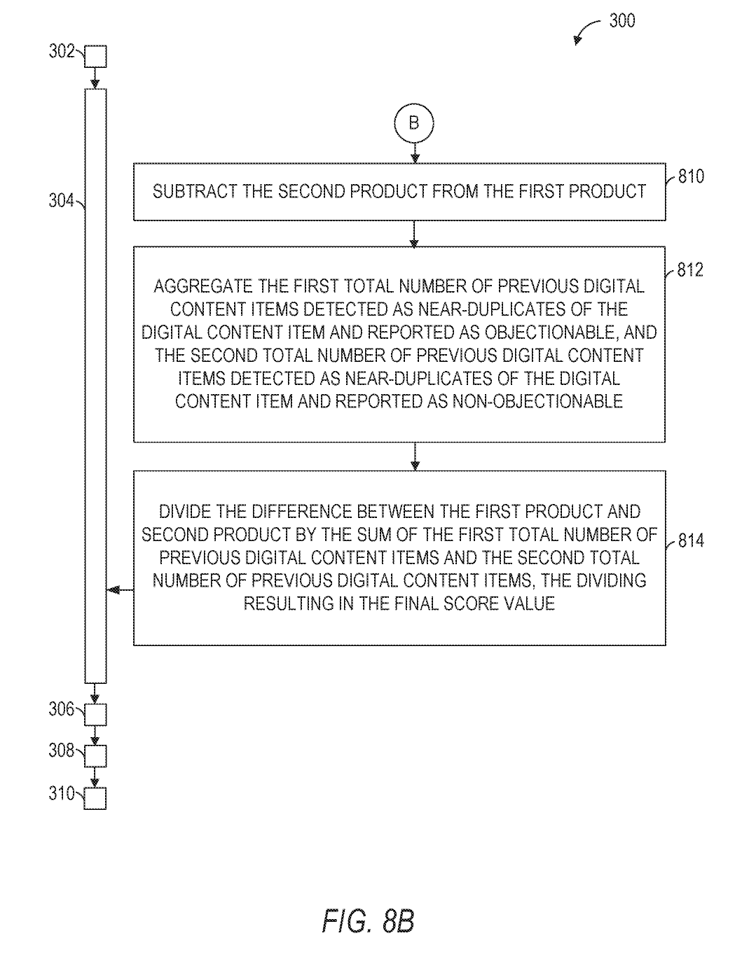

As shown in FIG. 8A, the method 300 may include one or more of the operations 802, 804, 806, or 808, according to some example embodiments. Operation 802 may be performed as part (e.g., a precursor task, a subroutine, or a portion) of operation 304 of FIG. 3, in which the analysis module 204 generates a final score value associated with the digital content item.

At operation 802, the analysis module 204 accesses a first near-duplicate counter value at a record of a database. The first near-duplicate counter value identifies a first total number of previous digital content items that were detected as near-duplicates of the digital content item and that were reported as objectionable.

At operation 804, the analysis module 204 accesses a second near-duplicate counter value at the record of the database. The second near-duplicate counter value identifies a second total number of previous digital content items that were detected as near-duplicates of the digital content item and that were reported as non-objectionable.

At operation 806, the analysis module 204 generates a first product between a first similarity value that identifies the degree of similarity between the digital content item and a first previous digital content item that was reported as objectionable, and a first base score associated with the first previous digital content item that was reported as objectionable.

At operation 808, the analysis module 204 generates a second product between a second similarity value that identifies the degree of similarity between the digital content item and a second previous digital content item that was reported as non-objectionable, and a second base score associated with the second previous digital content item that was reported as non-objectionable.

As shown in FIG. 8A, additional operations of the method 300 of FIG. 8A are illustrated in FIG. 8B.

FIG. 8B illustrates additional operations of the method 300 of FIG. 8A. As shown in FIG. 8B, the method 300 shown in FIG. 8A may include one or more of the operations 810, 812, or 814, according to some example embodiments. Operation 810 may be performed as part (e.g., a precursor task, a subroutine, or a portion) of operation 304 of FIG. 8A, after operation 808 of FIG. 8A, in which the analysis module 204 generates a second product between a second similarity value that identifies the degree of similarity between the digital content item and a second previous digital content item that was reported as non-objectionable, and a second base score associated with the second previous digital content item that was reported as non-objectionable.

At operation 810, the analysis module 204 subtracts the second product from the first product. The subtracting results in a difference between the first product and the second product.

At operation 812, the analysis module 204 aggregates the first total number of previous digital content items that were detected as near-duplicates of the digital content item and that were reported as objectionable, and the second total number of previous digital content items that were detected as near-duplicates of the digital content item and that were reported as non-objectionable. The aggregating of the first total number and the second total number resulting in a sum of the first total number of previous digital content items and the second total number of previous digital content items.

At operation 814, the analysis module 204 divides the difference between the first product and the second product by the sum of the first total number of previous digital content items and the second total number of previous digital content items. The dividing results in the final score value.

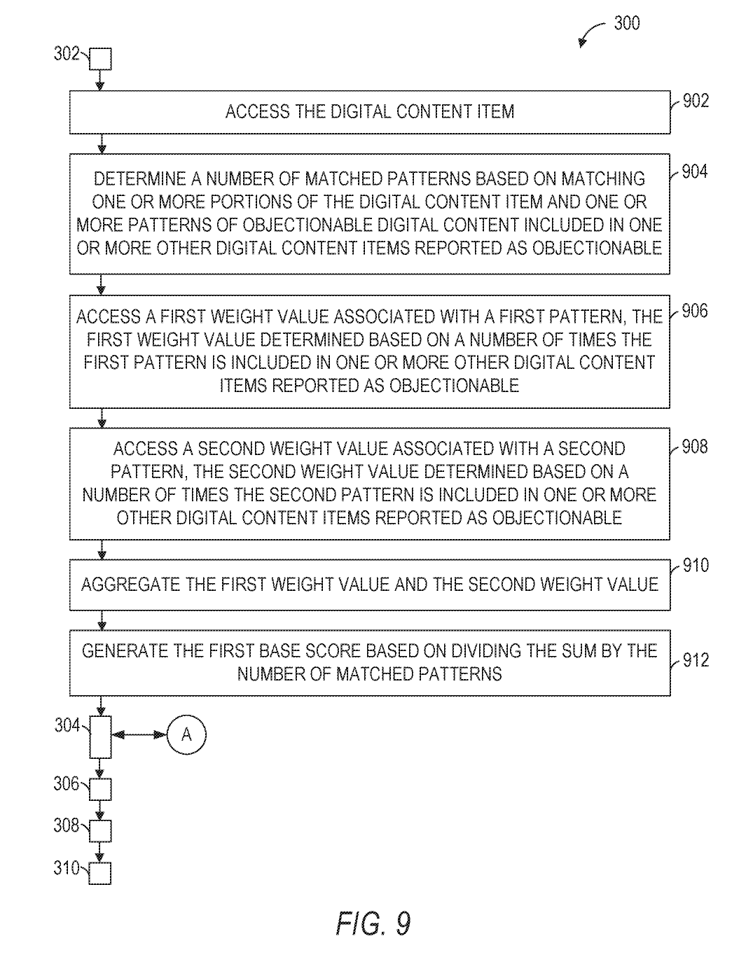

As shown in FIG. 9, the method 300 may include one or more of the operations 902, 904, 906, 908, 910, or 912, according to some example embodiments. Operation 902 may be performed after operation 302 of FIG. 8A, in which the access module 202 accesses a signal value that indicates that a digital content item is non-objectionable.

At operation 902, the access module 302 accesses the digital content item associated with the signal value. The access module 302 may accesses the digital content item from a record of a database that stores the digital content item.

At operation 904, the analysis module 304 determines a number of matched patterns based on matching one or more portions of the digital content item and one or more patterns of objectionable digital content included in one or more other digital content items previously reported as objectionable.

At operation 906, the access module 302 accesses a first weight value associated with a first pattern. The first weight value may be determined based on a number of times the first pattern is included in one or more other digital content items previously reported as objectionable.

At operation 908, the access module 302 accesses a second weight value associated with a second pattern. The second weight value may be determined based on a number of times the second pattern is included in one or more other digital content items previously reported as objectionable.

At operation 910, the analysis module 304 aggregates the first weight value and the second weight value. The aggregating may result in a sum of the first weight value and the second weight value.

At operation 912, the analysis module 304 generates the first base score associated with the first previous digital content item that was reported as objectionable based on dividing the sum of the first weight value and the second weight value by the number of matched patterns.

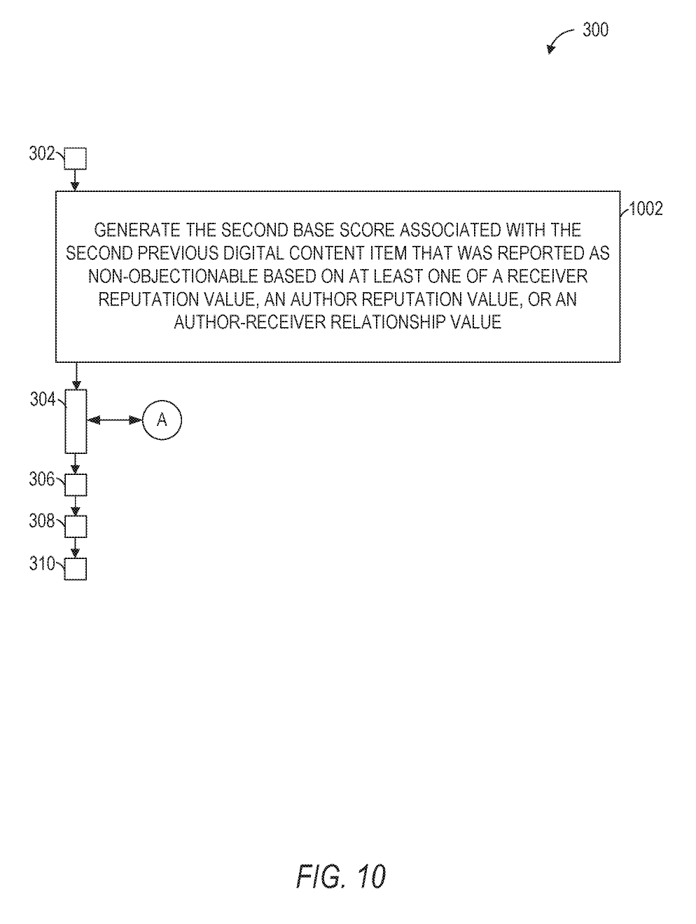

As shown in FIG. 10, the method 300 may include operation 1002, according to some example embodiments. Operation 1002 may be performed after operation 302 of FIG. 8A, in which the access module 202 accesses a signal value that indicates that a digital content item is non-objectionable.

At operation 1002, the analysis module 304 generates the second base score associated with the second previous digital content item that was reported as non-objectionable based on at least one of a receiver reputation value, an author reputation value, or an author-receiver relationship value.

Example Mobile Device

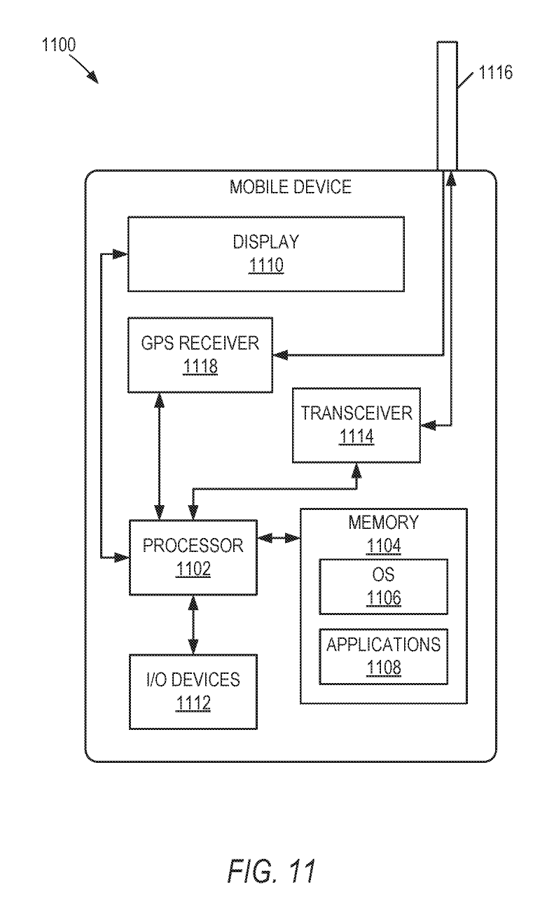

FIG. 11 is a block diagram illustrating a mobile device 1100, according to an example embodiment. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g, as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Example Machine Architecture and Machine-Readable Medium

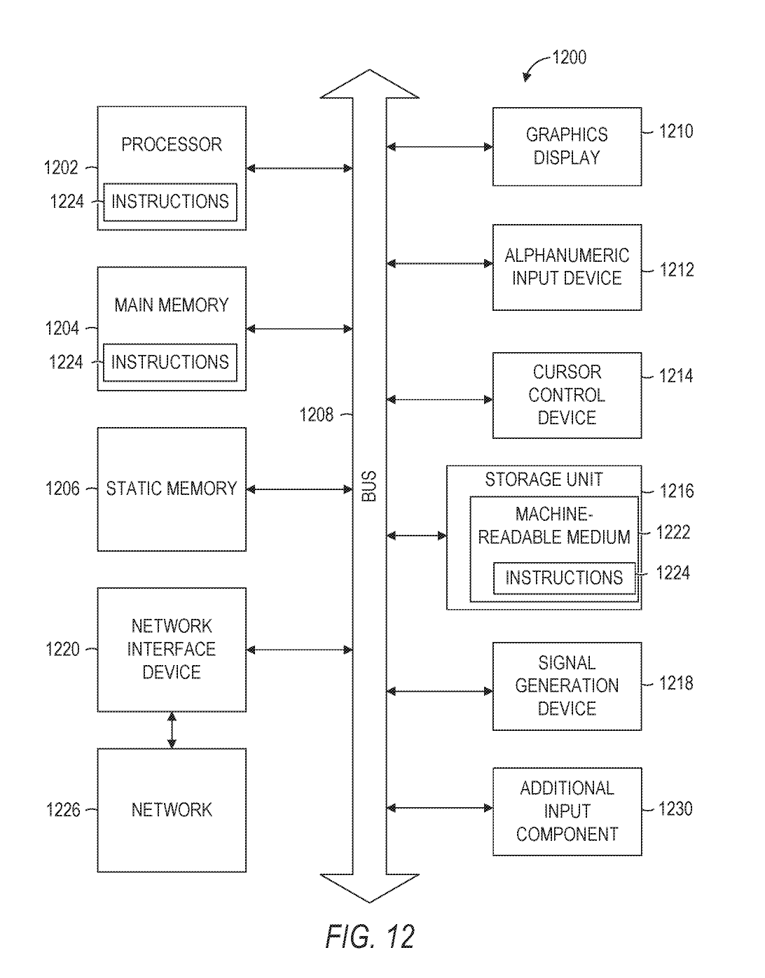

FIG. 12 is a block diagram illustrating components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 1222 (e.g., a tangible and non-transitory machine-readable storage medium) on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 1226 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components 1230 (e.g., sensors or gauges). Examples of such input components 1230 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a signal value that indicates that a digital content item is non-objectionable;
in response to the accessing of the signal value, generating a final score value for the digital content item based on one or more signal values associated with one or more near-duplicates of the digital content item, the final score value indicating a level of objectionability of the digital content item, the generating being performed using one or more hardware processors;
determining that the final score value does not exceed a threshold value associated with a treatment of digital content items;
modifying a status of the digital content item from objectionable to non-objectionable in a record of a database based on the determining that the final score value does not exceed the threshold value, the modified status indicating that the digital content item is a non-objectionable digital content item; and
causing a display of an identifier associated with the digital content item in a user interface of a client device, the identifier indicating that the digital content item is non-objectionable.

2. The method of claim 1, wherein the signal value is received from the client device, the signal value being generated based on a member of a social networking service (SNS) marking the digital content item as non-objectionable in a spam folder associated with a mail client at the client device.

3. The method of claim 1, wherein the generating of the final score value is further based on a receiver reputation value associated with a member of a social networking service (SNS), the member being associated with the client device, the signal value being generated at the client device based on an action pertaining to the status of the digital content item by the member.

4. The method of claim 3, further comprising:
generating the receiver reputation value associated with the member based on a classification of the digital content item in response to the accessing of the signal value that indicates that the digital content item is non-objectionable.

5. The method of claim 4, wherein the classification is performed by a classification engine.

6. The method of claim 4, wherein the classification is performed by a human reviewer.

7. The method of claim 3, further comprising:
accessing a further record of the database associated with the SNS, the further record including the receiver reputation value associated with the member; and
dynamically increasing the receiver reputation value associated with the member based on a determination that the digital content item should be classified as non-objectionable,
wherein the generating of the final score value further based on the receiver reputation value associated with the member includes generating of the final score value further based on the dynamically increased receiver reputation value associated with the member.

8. The method of claim 1, further comprising:
determining that an author of the digital content item and a member of a social networking service (SNS) have a relationship via the SNS, the member being associated with the client device, the signal value being generated at the client device based on an action pertaining to the status of the digital content item by the member,
wherein the generating of the final score value is further based on the determining that the author of the digital content item and the member of the SNS have the relationship via the SNS.

9. The method of claim 1, wherein the generating of the final score value includes:
accessing a first near-duplicate counter value at a further record of the database, the first near-duplicate counter value identifying a first total number of previous digital content items that were detected as near-duplicates of the digital content item and that were reported as objectionable;
accessing a second near-duplicate counter value at the further record of the database, the second near-duplicate counter value identifying a second total number of previous digital content items that were detected as near-duplicates of the digital content item and that were reported as non-objectionable;
generating a first product between a first similarity value that identifies the degree of similarity between the digital content item and a first previous digital content item that was reported as objectionable, and a first base score associated with the first previous digital content item that was reported as objectionable;
generating a second product between a second similarity value that identifies the degree of similarity between the digital content item and a second previous digital content item that was reported as non-objectionable, and a second base score associated with the second previous digital content item that was reported as non-objectionable;
subtracting the second product from the first product, the subtracting resulting in a difference between the first product and the second product;
aggregating the first total number of previous digital content items that were detected as near-duplicates of the digital content item and that were reported as objectionable, and the second total number of previous digital content items that were detected as near-duplicates of the digital content item and that were reported as non-objectionable, the aggregating of the first total number and the second total number resulting in a sum of the first total number of previous digital content items and the second total number of previous digital content items; and
dividing the difference between the first product and the second product by the sum of the first total number of previous digital content items and the second total number of previous digital content items, the dividing resulting in the final score value.

10. The method of claim 9, further comprising:
accessing the digital content item associated with the signal value;
determining a number of matched patterns based on matching one or more portions of the digital content item and one or more patterns of objectionable digital content included in one or more other digital content items previously reported as objectionable;
accessing a first weight value associated with a first pattern, the first weight value being determined based on a number of times the first pattern is included in one or more other digital content items previously reported as objectionable;
accessing a second weight value associated with a second pattern, the second weight value being determined based on a number of times the second pattern is included in one or more other digital content items previously reported as objectionable;
aggregating the first weight value and the second weight value, the aggregating resulting in a sum of the first weight value and the second weight value; and
generating the first base score associated with the first previous digital content item that was reported as objectionable based on dividing the sum of the first weight value and the second weight value by the number of matched patterns.

11. The method of claim 9, further comprising:
generating the second base score associated with the second previous digital content item that was reported as non-objectionable based on at least one of a receiver reputation value, an author reputation value, or an author-receiver relationship value.

12. A system comprising:
one or more hardware processors; and
a machine-readable medium for storing instructions that, when executed by the one or more hardware processors, cause the one or more hardware processors to perform operations comprising:
accessing a signal value that indicates that a digital content item is non-objectionable;
in response to the accessing of the signal value, generating a final score value for the digital content item based on one or more signal values associated with one or more near-duplicates of the digital content item, the final score value indicating a level of objectionability of the digital content item;
determining that the final score value does not exceed a threshold value associated with a treatment of digital content items;
modifying a status of the digital content item from objectionable to non-objectionable in a record of a database based on the determining that the final score value does not exceed the threshold value, the modified status indicating that the digital content item is a non-objectionable digital content item; and
causing a display of an identifier associated with the digital content item in a user interface of a client device, the identifier indicating that the digital content item is non-objectionable.

13. The system of claim 12, wherein the generating of the final score value is further based on a receiver reputation value associated with a member of a social networking service (SNS), the member being associated with the client device, the signal value being generated at the client device based on an action pertaining to the status of the digital content item by the member.

14. The system of claim 13, further comprising:
generating the receiver reputation value associated with the member based on a classification of the digital content item in response to the accessing of the signal value that indicates that the digital content item is non-objectionable.

15. The system of claim 13, wherein the operations further comprise:
accessing a further record of the database associated with the SNS, the further record including the receiver reputation value associated with the member; and
dynamically increasing the receiver reputation value associated with the member based on a determination that the digital content item should be classified as non-objectionable,
wherein the generating of the final score value further based on the receiver reputation value associated with the member includes generating of the final score value further based on the dynamically increased receiver reputation value associated with the member.

16. The system of claim 12, wherein the operations further comprise:
determining that an author of the digital content item and a member of a social networking service (SNS) have a relationship via the SNS, the member being associated with the client device, the signal value being generated at the client device based on an action pertaining to the status of the digital content item by the member,
wherein the generating of the final score value is further based on the determining that the author of the digital content item and the member of the SNS have the relationship via the SNS.

17. The system of claim 12, wherein the generating of the final score value includes:
accessing a first near-duplicate counter value at a further record of the database, the first near-duplicate counter value identifying a first total number of previous digital content items that were detected as near-duplicates of the digital content item and that were reported as objectionable;
accessing a second near-duplicate counter value at the further record of the database, the second near-duplicate counter value identifying a second total number of previous digital content items that were detected as near-duplicates of the digital content item and that were reported as non-objectionable;
generating a first product between a first similarity value that identifies the degree of similarity between the digital content item and a first previous digital content item that was reported as objectionable, and a first base score associated with the first previous digital content item that was reported as objectionable;
generating a second product between a second similarity value that identifies the degree of similarity between the digital content item and a second previous digital content item that was reported as non-objectionable, and a second base score associated with the second previous digital content item that was reported as non-objectionable;
subtracting the second product from the first product, the subtracting resulting in a difference between the first product and the second product;
aggregating the first total number of previous digital content items that were detected as near-duplicates of the digital content item and that were reported as objectionable, and the second total number of previous digital content items that were detected as near-duplicates of the digital content item and that were reported as non-objectionable, the aggregating of the first total number and the second total number resulting in a sum of the first total number of previous digital content items and the second total number of previous digital content items; and
dividing the difference between the first product and the second product by the sum of the first total number of previous digital content items and the second total number of previous digital content items, the dividing resulting in the final score value.

18. The system of claim 17, wherein the operations further comprise:
accessing the digital content item associated with the signal value;
determining a number of matched patterns based on matching one or more portions of the digital content item and one or more patterns of objectionable digital content included in one or more other digital content items previously reported as objectionable;
accessing a first weight value associated with a first pattern, the first weight value being determined based on a number of times the first pattern is included in one or more other digital content items previously reported as objectionable;
accessing a second weight value associated with a second pattern, the second weight value being determined based on a number of times the second pattern is included in one or more other digital content items previously reported as objectionable;
aggregating the first weight value and the second weight value, the aggregating resulting in a sum of the first weight value and the second weight value; and
generating the first base score associated with the first previous digital content item that was reported as objectionable based on dividing the sum of the first weight value and the second weight value by the number of matched patterns.

19. The system of claim 17, wherein the operations further comprise:
generating the second base score associated with the second previous digital content item that was reported as non-objectionable based on at least one of a receiver reputation value, an author reputation value, or an author-receiver relationship value.

20. A non-transitory machine-readable storage medium comprising instructions that, when executed by one or more hardware processors of a machine, cause the one or more hardware processors to perform operations comprising:
accessing a signal value that indicates that a digital content item is non-objectionable;
in response to the accessing of the signal value, generating a final score value for the digital content item based on one or more signal values associated with one or more near-duplicates of the digital content item, the final score value indicating a level of objectionability of the digital content item;
determining that the final score value does not exceed a threshold value associated with a treatment of digital content items;
modifying a status of the digital content item from objectionable to non-objectionable in a record of a database based on the determining that the final score value does not exceed the threshold value, the modified status indicating that the digital content item is a non-objectionable digital content item; and
causing a display of an identifier associated with the digital content item in a user interface of a client device, the identifier indicating that the digital content item is non-objectionable.
